(19) United States
(12) Patent Application Publication
(10) Pub. No.: US 2008/0171458 A1
(43) Pub. Date: Jul. 17, 2008

(54) APPARATUS FOR FACILITATING VIDEO CONNECTIONS TO SURVEILLANCE DEVICES

(75) Inventor: David DeLisser, Tappan, NY (US)

Correspondence Address: PELCO, 3500 PELCO WAY, CLOVIA, CA, 93612, US

(73) Assignee: Pelco, Inc., Clovis, CA (US)

(21) Appl. No.: 12/016,016

(22) Filed: Jan. 17, 2008

Related U.S. Application Data
(60) Provisional application No. 60/881,025, filed on Jan. 17, 2007.

(51) Int. Cl. H01R 29/00

(52) U.S. Cl. 439/188

(57) ABSTRACT

An apparatus for facilitating video connections to surveillance devices comprising a plurality of twisted pair input connectors for receiving twisted pair wire connectors with each of the twisted pair wire connectors providing a video channel, a plurality of BNC output connectors, a ribbon cable connector and circuitry for connecting each channel to one of the plurality of BNC output connectors and the ribbon cable.

### CROSS-REFERENCE TO RELATED APPLICATION

This application claims the benefit of U.S. Provisional Application No. 60/881,025, entitled Receiver for Security System Applications, and filed Jan. 17, 2007. U.S. Provisional Application No. 60/881,025 is hereby incorporated by reference.

### STATEMENT REGARDING FEDERALLY SPONSORED RESEARCH OR DEVELOPMENT

N/A

### BACKGROUND OF THE INVENTION

This invention pertains to video surveillance systems and, in particular, to an apparatus for facilitating video connections to surveillance system devices.

The video security industry has begun to use category five and category six unshielded twisted pair (UTP) cable to transmit video data from cameras to switches and recorders. As the number of cameras used in a security system has increased, the various amplifiers and system components are being packaged in multi-channel configurations to increase density and reduce cost per channel. Commercially available multi-channel twisted pair receivers have two terminals for each twisted pair input, and a BNC (bayonet Neill-Concelman) output for each channel. In order to use the present day receivers in typical systems, the BNC output must go to both a recorder and to a viewing and control switch, commonly referred to in the industry as a matrix switch or matrix switch/controller. If neither of these devices is able to support a loop out configuration, then a multi-channel distribution amplifier is also needed for each camera channel, further adding to the cost and the wiring complexity.

Coax cables with BNC connectors have been the most common form of connection to a matrix switch. If looping out is needed, such as to record each input, the number of BNC connectors on the matrix doubles, causing a corresponding doubling of the physical size of the matrix interconnect panel. In some cases, this problem has been solved by moving the necessary BNC connectors to a remote connection panel, with a more dense ribbon type cable and connector running from the matrix to the patch panel. This simply moves the large BNC panel to a remote location and adds complexity.

Accordingly, there has been a long felt need in the industry for a way to provide the required video connections while reducing the size of the matrix switch/controller and the wiring complexity.

### SUMMARY OF THE INVENTION

In accordance with the present invention there is provided an apparatus for facilitating video connections to surveillance devices comprising a plurality of twisted pair input connectors for receiving twisted pair wire connectors with each of the twisted pair wire connectors providing a video channel, a plurality of BNC output connectors, a ribbon cable connector and circuitry for connecting each channel to one of the plurality of BNC output connectors and the ribbon cable.

In a further aspect of the present invention there is provided an apparatus for facilitating video connections to surveillance devices comprising a plurality of input connectors, the input connectors comprising a first type of connector, with each of the input connectors providing a video channel, a plurality of output connectors, the output connectors comprising a second type of connector that is a different type than the first type of connector, a multi-wire connector; and circuitry for connecting each channel to one of the plurality of output connectors and the multi-wire connector.

In still a further aspect of the present invention there is provided a surveillance system comprising a first camera having a first twisted pair output connector for providing a first channel of video, a second camera having a second twisted pair output connector for providing a second channel of video, a receiving device for receiving the first and second channels of video, the receiving device comprising a first twisted pair input connector for receiving the first twisted pair output connector, a second twisted pair input connector for receiving the second twisted pair output connector, first and second BNC output connectors, a ribbon cable connector, and circuitry for connecting the first twisted pair output connector to the first BNC out put connector and the ribbon cable connector and for connecting the second twisted pair output connector to the BNC output connector and the ribbon cable connector, and a matrix switch connected to the receiving device by a ribbon cable connected to the ribbon cable connector in the receiving device.

The present invention solves the problems caused by the shortcomings of the prior art by connecting the twisted pair cable to the twisted pair receiver as before and adding multiple two channel distribution amplifiers internally and a high density ribbon or similar output connector and cable to efficiently go between the receiver and the matrix. The single BNC outputs remain available and buffered to feed a video recorder or any other accessory. In this way the present invention provides a buffered channel available to drive both the ribbon cable and the corresponding accessory channels. A failure on one of the outputs will not impact the other buffered channel. Both the receiver and matrix physical size are minimized, as well as the number of interconnecting wires and corresponding connections. The overall result is a physically smaller, more reliable, easier to install system at lower cost. This is very important as today's security systems are sometimes exceeding 2,000 cameras.

The receiver of the present invention can also be utilized with a multi-channel fiber receiver or a multi-channel differential video receiver.

Other advantages and applications of the present invention will be made apparent by the following detailed description of the preferred embodiment of the invention.

### BRIEF DESCRIPTION OF THE DRAWING

FIG. 1 is a schematic block diagram of one embodiment of the present invention.

### DETAILED DESCRIPTION OF THE INVENTION

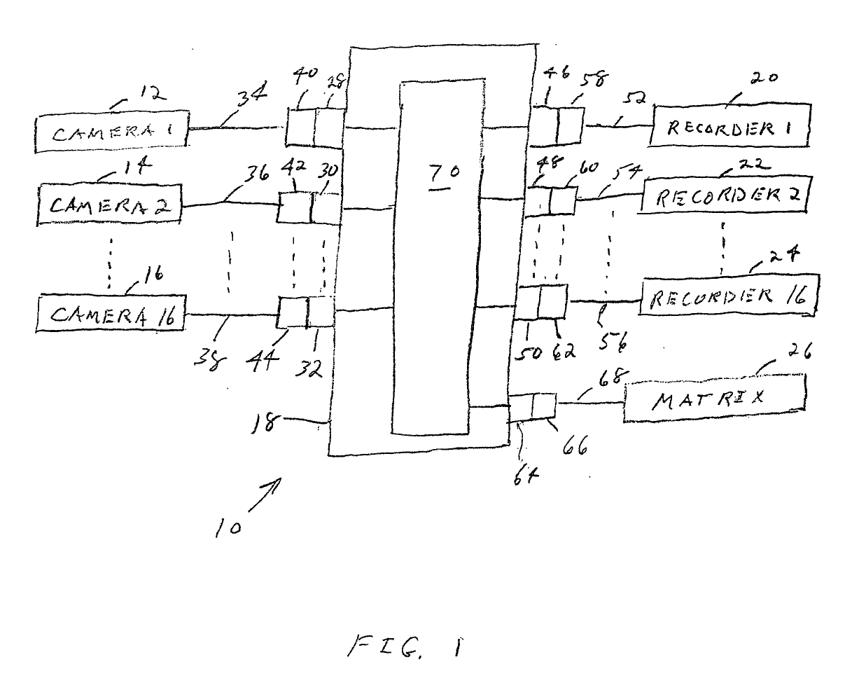

Referring to FIG. 1, video surveillance system 10 has a plurality of cameras, for example sixteen, which are shown by numerals 12, 14, and 16 for camera 1, camera 2, and camera 16. The dotted lines between cameras 14 and 16 indicate the other thirteen cameras, which have been omitted to simplify the drawing. Similarly, the dotted lines included elsewhere in FIG. 1 indicate the missing additional items located adjacent to the dotted lines. Surveillance system 10 also has a receiver 18, a plurality of video recorders, such as digital video recorders, which are indicated by numerals 20, 22, and 24 and a matrix 26, which can be a viewing and control switch. Receiver 18 has twisted pair type connectors 28, 30, and 32, such as RJ45, so that the unshielded twisted pair wires 34, 36, and 38 from cameras 12, 14, and 16 can be connected by means of the twisted pair type connectors 40, 42, and 44 at the ends of unshielded twisted pair wires 34, 36, and 38. Receiver 18 also has a plurality of BNC type connectors 46, 48 and 50. Recorders 20, 22, and 24 have coaxial cables 52, 54, and 56 with BNC connectors 58, 60, and 62 to connect with BNC connectors 46, 48, and 50 of receiver 18. In addition to the BNC type connectors, receiver 18 also has ribbon cable connector 64 or other high density, multi-wire connector, which connects with ribbon cable connector 66 on one end of ribbon cable 68 to connect receiver 18 with matrix 26. Receiver 18 has circuit 70, which can be an a multi-channel, buffered amplifier that provides the video signal from twisted pair connectors 28, 30, and 32 to BNC connectors 46, 48, and 50 respectively. Circuit 70 also provides each of the video signals from twisted pair connectors 28, 30, and 32 to ribbon cable connector 64. Circuit 70 can provide isolation so that in the event of a fault on one or more of BNC connectors 46, 48, and 50 it will not affect the signals on ribbon connector 64 and vice versa. Accordingly, the present invention provides buffered BNC outputs to feed the video signals from the cameras to a video recorder or any other accessory while still providing the plurality of channels of video signals to the matrix. The present invention minimizes the physical size of both the receiver and matrix, facilitates installation, and reduces the cost of the system.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. An apparatus for facilitating video connections to surveillance devices comprising:
a plurality of twisted pair input connectors for receiving twisted pair wire connectors with each of said twisted pair wire connectors providing a video channel;
a plurality of BNC output connectors;
a ribbon cable connector; and
circuitry for connecting each channel to one of said plurality of BNC output connectors and said ribbon cable.

2. An apparatus as recited in claim 1 wherein said circuitry comprises a two channel amplifier.

3. An apparatus as recited in claim 2 wherein said amplifier is a buffered amplifier.

4. An apparatus as recited in claim 1, wherein one of said surveillance devices comprises a matrix switch.

5. An apparatus as recited in claim 1, wherein one of said surveillance devices comprises a video recorder.

6. An apparatus as recited in claim 1, wherein a failure on one of said BNC output connectors does not affect said ribbon cable and a failure on said ribbon cable does not affect said BNC output connectors.

7. An apparatus as recited in claim 1 wherein said circuitry is a two channel buffered amplifier and one of said surveillance devices comprises a matrix switch.

8. An apparatus for facilitating video connections to surveillance devices comprising:
a plurality of input connectors, said input connectors comprising a first type of connector, with each of said input connectors providing a video channel;
a plurality of output connectors, said output connectors comprising a second type of connector that is a different type than said first type of connector;
a multi-wire connector; and
circuitry for connecting each channel to one of said plurality of output connectors and said multi-wire connector.

9. An apparatus as recited in claim 8 wherein said circuitry is a two channel buffered amplifier and one of said surveillance devices comprises a matrix switch.

10. A surveillance system comprising:
a first camera having a first twisted pair output connector for providing a first channel of video;
a second camera having a second twisted pair output connector for providing a second channel of video;
a receiving device for receiving said first and second channels of video, said receiving device comprising a first twisted pair input connector for receiving said first twisted pair output connector, a second twisted pair input connector for receiving said second twisted pair output connector, first and second BNC output connectors, a ribbon cable connector, and circuitry for connecting said first twisted pair output connector to said first BNC out put connector and said ribbon cable connector and for connecting said second twisted pair output connector to said BNC output connector and said ribbon cable connector; and
a matrix switch connected to said receiving device by a ribbon cable connected to said ribbon cable connector in said receiving device.
